(19) United States
(12) Patent Application Publication
(10) Pub. No.: US 2011/0210679 A1
(43) Pub. Date: Sep. 1, 2011

(54) Device and method for activating LED strings

(76) Inventors: Thorsten KOEPKE, Reutlingen (DE); Werner SCHIEMANN, Fellbach (DE)

(21) Appl. No.: 13/024,906

(22) Filed: Feb. 10, 2011

(30) Foreign Application Priority Data
Feb. 26, 2010 (DE) 102010002386.8

(51) Int. Cl. H05B 37/02

(52) U.S. Cl. 315/192

(57) ABSTRACT

A device for activating at least two LED strings includes a source of electrical power, a switching controller and at least two LED strings having one or more LED(s). The switching controller in this case includes means for generating an essentially constant current, and the LED strings cooperate with the switching controller in such a way that at least one of the LED strings is supplied with current at least part of the time using the essentially constant current generated by the means.

### BACKGROUND INFORMATION

LEDs which are used for illumination purposes are usually connected in series, and then exist in the form of an LED string. Often a plurality of such strings—even having a different number of LEDs or different types of LEDs—is operated simultaneously. A device for activating LED strings is described in U.S. Patent Publication No. 2009/0012845. In this case the device includes a voltage source, to the output of which a plurality of LED strings is connected in parallel, the individual LEDs of each LED string being connected in series. Each LED string includes a regulator which determines the current individually for the respective LED string, and adjusts it if necessary in order to achieve a particular luminosity.

Another device for activating LED strings is described in U.S. Patent Publication No. US 2007/0069664. The particular LED strings are wired in parallel to each other, and are connected to a common voltage source. Situated within each LED string is a voltage transformer, which controls or adjusts the voltage of the source appropriately for the individual LED string in order to obtain a desired brightness of the LED string or of the individual LEDs.

Another device for activating an LED string is described in U.S. Patent Publication No. 2008/0272651. In this case, the individual LED strings are again connected in parallel to a voltage source. The particular current through an LED string is measured on the basis of a reference string, a control device then controlling the current for the individual LED strings with the aid of transistors.

In principle, it is common to all the above-named devices that a voltage transformer uses a voltage from a voltage source to make a supply voltage available for LED strings connected in parallel. The particular current through the LED strings is then generated in the form of a current sink, for example with the aid of pulse-width modulation controllers or linear controllers. These controllers are expensive, and in addition the latter type in particular is subject to losses; i.e., they consume additional electrical power.

### SUMMARY OF THE INVENTION

The device for activating at least two LED strings and the corresponding method for activating at least two LED strings have the advantage that only a single switching controller needs to be provided to operate the LED strings. Current is applied to the LED strings on the basis of the means for generating an essentially constant current, and this current is conducted at least part of the time directly to at least one of the LED strings. The additional transformation of the electrical power to a voltage adjusted for the particular LED string, as well as the associated placement of one or more current sinks in the particular LED string, is thereby avoided. This reduces electrical losses due to the transformation and the number of current sinks, as well as the number of components needed to activate the LED strings. The previously needed adjustment of a current in each particular LED string is thus also eliminated. A corresponding current measurement for checking the current through the particular LED string, which is subject to loss, may also be dispensed with. On the whole, the costs of a device for activating LED strings are lowered significantly thereby. At the same time, servicing also becomes simpler and more economical, since fewer components may need to be replaced.

An idea underlying the present invention therefore is avoiding the detour via a voltage adjustment from a source of electrical power, as well as additional current sinks, for controlling the current in the individual LED strings.

According to a preferred refinement, the switching controller, in particular the means for generating an essentially constant current, includes an inductance; in particular, a magnitude of the essentially constant current may be established via the inductance. The advantage of this is that the magnitude of the essentially constant current may thereby be established in a simple way, so that this magnitude of the current is known already before the current is distributed to the respective LED strings, and expensive regulation in the respective LED string is eliminated.

According to another preferred refinement, the switching controller includes at least one current regulator. The current regulator enables simple and economical conversion and regulation of the electrical power supplied by the source into a current, since an additional capacitor needed with a voltage regulator may be dispensed with.

According to another preferred refinement, the device includes an apparatus for time-dependent current supply to at least one LED string. The advantage of this is that the brightness of at least one LED string is thereby variable in a simple and economical manner, for example by supplying current to the corresponding LED string longer when the LEDs of the LED string are supposed to shine more brightly. If the brightness of the LEDs is to be reduced, current then flows to the corresponding LED string for a correspondingly shorter time.

According to another preferred refinement, the apparatus for time-dependent current supply includes a microcontroller. The advantage of this is that the microcontroller is able to control, extremely quickly, appropriate switches for supplying current to the particular LED string. In particular, if it is also programmable, then it is also possible for example to connect a brightness sensor to the microcontroller, which measures an ambient brightness. The microcontroller is then able to control the current supply to the LED string according to the ambient brightness, so that the brightness of the LEDs is adjusted to the ambient brightness. That makes it possible to reduce the electrical power needed to operate the LEDs.

According to another preferred refinement, balancing means are provided for at least one LED string. The advantage of this is that the LEDs of the one LED string are activated or supplied with current as constantly as possible. This ensures more uniform and more reliable light output of the LEDs.

According to another preferred refinement, the balancing means include at least one capacitor, which is connected in parallel to at least one LED string. The advantage of this is that the capacitor provides for more uniform light output of the LEDs of the LED string in a simple and economical way. Any voltage spikes which may occur when switching the particular LED string off or on are for the most part eliminated thereby. The life of the LEDs is also increased thereby.

According to another preferred refinement, at least one LED string is controllable with the aid of a high-side and/or low-side switch, the high-side and/or low-side switch including at least one semiconductor switch. The advantage of this is that the particular LED string is adaptable to special demands in a simple way. High-side switches are necessary for many applications in the automotive industry, in order to minimize the likelihood of power being switched on unintentionally by a short circuit. In particular if the switch is a semiconductor switch, it may be switched on and off again extremely quickly. At the same time, losses are minimized by using a semiconductor switch instead of a mechanical switch, for example a relay.

According to another preferred refinement, means are provided for measuring a magnitude of the generated current. The advantage of this is that the magnitude of the current may thereby be checked. In particular if a modern measuring method is used for this, for example a so-called high-side measurement using current-measuring amplifiers, the losses which usually occur in a current measurement are reduced significantly.

According to a preferred refinement of the method according to the present invention, this includes the step of “controlling the brightness of the at least one LED on the basis of time-based supply of at least one of the LED strings with the essentially constant current.” The advantage of this is that the brightness of the particular LED string may thereby be controlled very simply and economically, without the current intensity provided for that purpose having to be changed or adjusted overall.

### BRIEF DESCRIPTION OF THE DRAWINGS

FIG. 1 shows a device for activating at least two LED strings according to a first embodiment, in the form of a circuit diagram.

FIG. 2 shows a device for activating at least two LED strings according to an eighth embodiment, in the form of a circuit diagram.

### DETAILED DESCRIPTION

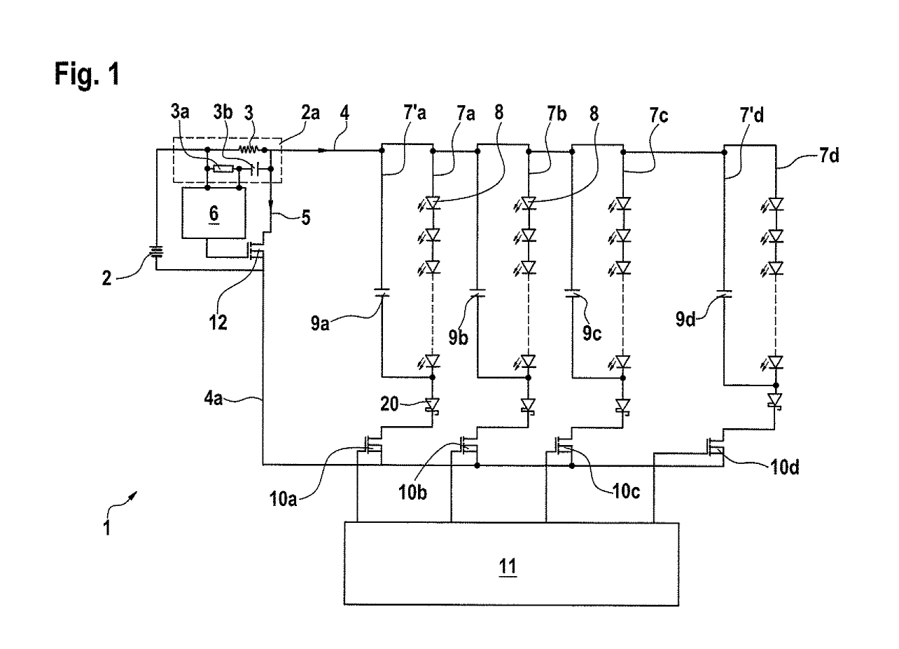

FIG. 1 shows a device for activating at least two LED strings according to a first embodiment, in the form of a circuit diagram.

In FIG. 1, reference numeral 1 designates a device for activating at least two LED strings according to the first embodiment of the present invention, including a source of electrical power 2 in the form of a voltage source, a switching controller 2a and four LED strings 7a-7d having one or more LED(s) 8. Switching controller 2a includes in this case a resistor 3a, a capacitor 3b, and an inductance in the form of a coil 3 connected in parallel thereto. A plurality of LED strings 7a-7d, connected in parallel to each other, are connected via a connection 4 to a current output of switching controller 2a. Capacitors 9a-9d are connected in parallel to the respective individual LED strings 7a-7d. Each of these combinations of a parallel-connected capacitor 9a and LED string 7a, 9b and 7b, 9c and 7c, 9d and 7d, is connected in series to a diode and also to a switch 10a, 10b, 10c, 10d. Using switches 10a, 10b, 10c, 10d, the particular combination of capacitor 9a and LED string 7a, 9b and 7b, 9c and 7c, 9d and 7d may be connected through line 4a to switching controller 2a or voltage source 2. Switches 10a, 10b, 10c, 10d are implemented as semiconductor switches, and are connected individually to a microcontroller 11, which controls the respective on time of switch 10a, 10b, 10c, 10d, and thereby indirectly the brightness of LEDs 8 situated in the particular switched-on LED string 7a-7d. At the upper left of FIG. 1, situated at a current output of switching controller 2a, through a semiconductor switch 12, is also a current measuring device 6, which in turn is also connected through another connection to switching controller 2a. Current measuring device 6 measures the current which is made available by switching controller 2a at its output for the respective LED string or strings 7a-7d or for the particular combination of capacitors 9a-9d and LED strings 7a-7d. Measurement of the particular current flowing through an LED string 7a, 7b, 7c, 7d, and in particular its adjustment to a predefined value, may thereby be entirely dispensed with.

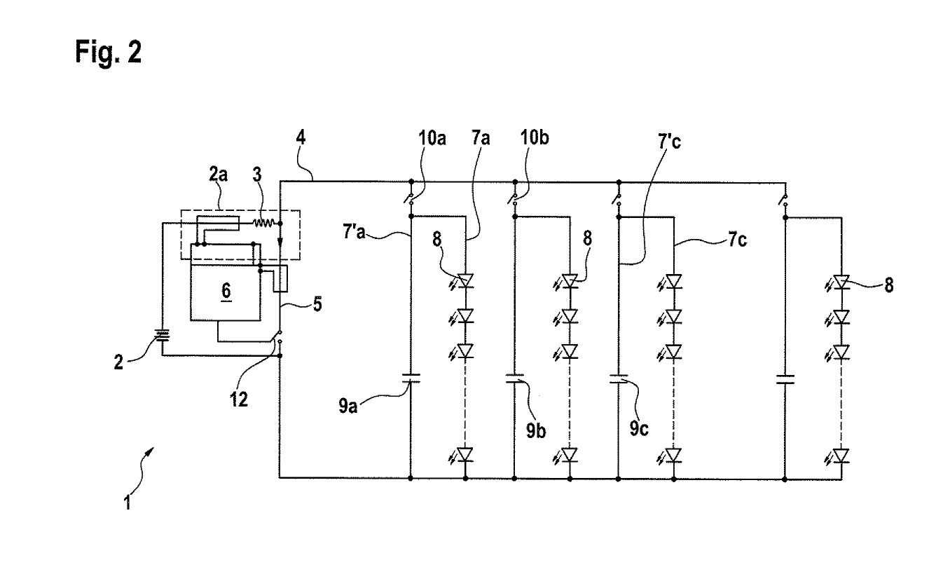

FIG. 2 shows a device for activating at least two LED strings according to an eighth embodiment, in the form of a circuit diagram.

In the case of device 1 for activating LED strings 7a-7d shown in FIG. 2, device 1 now includes high-side switches 10a-10d instead of the low-side switches 10a-10d of FIG. 1. These are situated between a connection in the form of a line 4 and the particular parallel connection of capacitor 9a and LED string 7a, 9b and 7b, 9c and 7c, 9d and 7d. A microcontroller (not shown here) again controls switches 10a, 10b, 10c, 10d individually.

What is claimed is:

1. A device for activating at least two LED strings comprising:
a source of electrical power;
a switching controller including means for generating a substantially constant current; and
at least two LED strings having one or more LEDs, the LED strings cooperating with the switching controller in such a way that at least one of the LED strings is supplied with current at least part of the time with the aid of the substantially constant current generated by the means for generating.

2. The device according to claim 1, wherein the means for generating includes an inductance, and wherein a magnitude of the substantially constant current may be established via the inductance.

3. The device according to claim 1, wherein the switching controller includes at least one current regulator.

4. The device according to claim 1, further comprising an apparatus for time-dependent current supply to at least one LED string.

5. The device according to claim 4, wherein the apparatus for time-dependent current supply includes a microcontroller.

6. The device according to claim 1, further comprising a balancing arrangement for at least one LED string.

7. The device according to claim 6, wherein the balancing arrangement includes at least one capacitor, which is connected in parallel with at least one LED string.

8. The device according to claim 1, wherein at least one LED string is controllable with the aid of a high-side and/or low-side switch, the switch including a semiconductor switch.

9. The device according to claim 1, further comprising means for measuring a magnitude of the generated current.

10. A method for activating LED strings comprising:
providing electrical power;
generating a substantially constant current from the electrical power provided;
providing the generated substantially constant current for at least two LED strings, each having at least one LED; and
generating light with the aid of at least one LED of at least one of the LED strings at least part of the time via the provided current.

11. The method according to claim 10, further comprising controlling a brightness of the at least one LED via time-controlled current supply to at least one of the LED strings with the generated substantially constant current.
